(19) United States
(12) Patent Application Publication
(10) Pub. No.: US 2013/0165351 A1
(43) Pub. Date: Jun. 27, 2013

(54) Method to Reduce Salt Necessary to Reach Saturation of Drilling Fluids

(71) Applicant: Baker Hughes Incorporated, Houston, TX (US)

(72) Inventors: Mohammad Tej, Houston, TX (US); David B. Young, Spring, TX (US); John B. Trenery, JR., Sugar Land, TX (US)

(73) Assignee: BAKER HUGHES INCORPORATED, Houston, TX (US)

(21) Appl. No.: 13/713,794

(22) Filed: Dec. 13, 2012

Related U.S. Application Data
(60) Provisional application No. 61/578,355, filed on Dec. 21, 2011.

(51) Int. Cl. C09K 8/06

(52) U.S. Cl. CPC C09K 8/06
USPC 507/139

(57) ABSTRACT

The addition of a non-aqueous, non-oleaginous component into an aqueous-based drilling fluid may reduce the amount of salt necessary for the aqueous-based drilling fluid to reach saturation. The amount of the non-aqueous, non-oleaginous component within the aqueous-based drilling fluid may range from about 5 vol % to about 95 vol %. The component may be, but is not limited to glycol, glycerin, polyol, alcohol, and combinations thereof. The aqueous-based drilling fluid may then be used for drilling a wellbore into a subterranean reservoir that contains salt and thereby prevent or inhibit the salt from being leached from the subterranean reservoir.

### CROSS-REFERENCE TO RELATED APPLICATIONS

This application claims the benefit of Provisional Patent Application No. 61/578,355 filed Dec. 21, 2011, which is incorporated herein by reference in its entirety.

### TECHNICAL FIELD

The present invention relates to a method for drilling a wellbore into a salt-containing subterranean reservoir using a aqueous-based drilling fluid having from about 5 vol % to about 95 vol % of a non-aqueous, non-oleaginous component selected from the group consisting of glycol, glycerin, polyol, alcohol, and combinations thereof.

### BACKGROUND

Drilling fluids used in the drilling of subterranean oil and gas wells along with other drilling fluid applications and drilling procedures are known. In rotary drilling, there are a variety of functions and characteristics that are expected of drilling fluids, also known as drilling muds, or simply “muds”. The drilling fluid should carry cuttings from beneath the bit, transport them through the annulus, and allow their separation at the surface while at the same time the rotary bit is cooled and cleaned. A drilling mud is also intended to reduce friction between the drill string and the sides of the hole, while maintaining the stability of uncased sections of the borehole. The drilling fluid is formulated to prevent unwanted influxes of formation fluids from permeable rocks penetrated and also often to form a thin, low permeability filter cake that temporarily seals pores, other openings and formations penetrated by the bit. The drilling fluid may also be used to collect and interpret information available from drill cuttings, cores and electrical logs. It will be appreciated that within the scope of the description and claims herein, the term “drilling fluid” also encompasses “drill-in fluids” and “completion fluids”.

Drilling fluids are typically classified according to their base fluid. In aqueous-based muds, solid particles are suspended in water or brine. Oil can be emulsified in the water. Nonetheless, the water is the continuous phase. Brine-based drilling fluids, of course are a aqueous-based mud in which the aqueous component is brine.

It is apparent to those selecting or using a drilling fluid for oil and/or gas exploration that an essential component of a selected fluid is that it be properly balanced to achieve the necessary characteristics for the specific end application. Because drilling fluids are called upon to perform a number of tasks simultaneously, this desirable balance is not always easy to achieve.

The density of aqueous drilling fluids may also be increased by dissolving salts therein. The density of the fluid is important because it must balance the density of the fluids in the formation and prevent them from entering the wellbore during drilling. Water activity (or aw) accounts for the intensity with which water may associate with various non-aqueous constituents and solids, i.e. it is a measure of the energy status of the water in a system. Pure distilled water has a water activity of exactly one. As the temperature increases, the water activity typically increases, except in some fluids with salts or sugars. To keep the water activity of an aqueous-based drilling fluid at a minimum, salts are typically added to the aqueous-based drilling fluid, which lowers the amount of water available for dissolving salts and/or other solutes and thereby reduces the amount of salt necessary for saturation. Such salts include, but are not necessarily limited to, sodium chloride, magnesium chloride, calcium chloride, potassium chloride, sodium formate, potassium formate, cesium formate, sodium bromide, calcium bromide, zinc bromide, ammonium chloride, zinc chloride, calcium nitrate, potassium acetate, magnesium acetate, calcium sulfate dihydrate, and combinations thereof.

Additionally, in situations where an operator is drilling through a formation containing salt, it is important that the drilling mud be near-saturation, at saturation or supersaturated with salts to inhibit or prevent the drilling mud from leaching salt from the formation during drilling. This is a particular concern when drilling through a salt dome, i.e. massive “sub-salt” beds typically found in offshore geological formations that may be hundreds to thousands of feet in thickness and depth or similar formation. As used herein, the term “at least saturated with salt” includes the condition of saturated with salt and supersaturated with salt.

‘Salt’ as used herein is defined as being at least salt from a salt dome or depositional salt. A salt dome has salt that has intruded into the formation and caused a salt dome to form. Depositional salt is also known to those skilled in the art as evaporites, which is where the salt has formed deposits within the formation. Depositional salt typically forms as a layer.

It would be desirable if a method were devised to reduce the water activity of an aqueous-based drilling fluid and thereby reduce the amount of salt required for the drilling fluid to reach saturation, which would in turn help to reduce the amount of salt leached from a salt-containing reservoir or formation.

### SUMMARY

There is provided, in one form, a method for drilling a wellbore into a salt-containing subterranean reservoir, e.g. a salt dome, using an aqueous-based drilling fluid. The aqueous-based drilling fluid may include a non-aqueous, non-oleaginous component in an amount ranging from about 5 vol % to about 95 vol %. The non-aqueous, non-oleaginous component may be, but is not limited to glycol, glycerin, polyol, alcohol, and combinations thereof.

In a non-limiting embodiment, the aqueous-based drilling fluid may include the non-aqueous, non-oleaginous component in an amount ranging from about 12 vol % to about 60 vol %. The water activity of the aqueous-based drilling fluid may be reduced compared to an otherwise identical aqueous-based drilling fluid absent the non-oleaginous component.

In another alternative embodiment, the aqueous-based drilling fluid may have a reduced amount of salt as compared to an otherwise identical aqueous-based drilling fluid absent the non-aqueous non-oleaginous component, which may reduce the amount of salt leached from the subterranean formation during drilling of the wellbore compared to an otherwise identical method absent the non-aqueous, non-oleaginous component. The salt in the subterranean reservoir and the salt in the aqueous-based drilling fluid may be the same or different.

### DETAILED DESCRIPTION

It has been discovered that the addition of a non-aqueous, non-oleaginous component into an aqueous-based drilling fluid may thereby lower the water activity of the aqueous-based drilling fluid compared to an otherwise identical aqueous-based drilling fluid absent the non-aqueous, non-oleaginous component and thereby reduce the amount of salt required for the aqueous-based drilling fluid to reach saturation. Less salt in the aqueous-based drilling fluid may prevent or inhibit salt from being leached from a salt-containing subterranean reservoir, e.g., a salt dome or the like, when drilling the wellbore. Prevent or inhibit is defined herein to mean that the non-aqueous, non-oleaginous component may suppress or reduce the amount of salt leached from a formation or reservoir having salt therein. That is, it is not necessary for the leaching of the salt from the salt-containing reservoir to be entirely prevented for the methods discussed herein to be considered effective, although complete prevention is a desirable goal.

The aqueous-based drilling fluid may include, but is not limited to water and a non-aqueous, non-oleaginous component. The amount of the component within the aqueous-based drilling fluid may range from about 5 vol % to about 95 vol %, alternatively from about 12 vol % independently to about 60 vol %, or from about 18 vol % independently to about 40 vol % in another non-limiting embodiment.

The non-aqueous, non-oleaginous component may be a low molecular weight polyol, such as but not limited to glycol, glycerin, polyols, alcohols, and combinations thereof. Non-limiting examples of the types of glycols that may be used or included are diethylene glycol, dipropylene glycol, hexylene glycol, monoethylene glycol, monopropylene glycol, polyethylene glycol, triethylene glycol, tripropylene glycol, glycol ethers, and combinations thereof. The molecular weight of the component may range from about 32 g/mol independently to about 1260 g/mol, from about 32 g/mol independently to about 1260 g/mol in another non-limiting embodiment, or alternatively from about 62 g/mol independently to about 600 g/mol. The non-aqueous, non-oleaginous component may have an attached functional group, such as hydroxyl in one non-limiting embodiment.

The non-aqueous non-oleaginous component may be added to the aqueous-based drilling fluid at or near the end stage of the fluid building process. However, it will be appreciated that the non-aqueous non-oleaginous component product may be added at any stage in the fluid building process. As noted, the non-aqueous non-oleaginous component is added and mixed into the drilling fluid to obtain the desired properties that lower the amount of salt required for the drilling fluid to reach saturation.

The aqueous-based drilling fluid may include, but is not limited to an oil-in-water fluid, an oil-in-brine fluid, and mixtures thereof. The salt in the subterranean reservoir and the salt in the aqueous-based drilling fluid may be the same or different; alternatively, the salt in the subterranean reservoir and the salt in the aqueous-based drilling fluid is the same where the salt was leached from the formation and into the aqueous-based drilling fluid. In one non-limiting instance, the salt may be or include, but is not necessarily limited to sodium chloride, magnesium chloride, calcium chloride, potassium chloride, sodium formate, potassium formate, cesium formate, ammonium formate, sodium bromide, potassium bromide, calcium bromide, zinc bromide, ammonium chloride, zinc chloride, calcium nitrate, potassium acetate, magnesium acetate, calcium sulfate dihydrate and combinations thereof.

The aqueous-based drilling fluids herein may also contain conventional additives and/or components such as suspended solids that may include, but are not limited to, weighting agents, e.g. high-gravity solids (HGS) such as barite (barium sulfate), hematite, siderite, ilmenite, manganese tetraoxide, calcium carbonate and the like, which may be added to a mud to increase its density (specific gravity), also known as weighting materials. Low gravity solids (LGS) may also be used. In the context herein, weighting agents including bridging agents, which may be many of the same materials noted herein for weighting agents, including, but not necessarily limited to, calcium carbonate, suspended salts or oil-soluble resins. Bridging agents are solids added to a drilling fluid to bridge across the pore throats or fractures of an exposed rock thereby building a filter cake to prevent loss of mud or excessive filtrate. Bentonite (sodium montmorillonite) is a useful additive for increasing the viscosity of drilling muds, as are other clays used as viscosifying agents, along with xanthan gum or guar gum polymers, polyanionic cellulosic polymer, and the like.

Other conventional additives or components for water- or brine-based drilling fluids include, but are not necessarily limited to, partially-hydrolyzed polyacrylamide (PHPA) (to control wellbore shales or extend bentonite clays), pH modifiers or adjusters (lime, KOH, NaOH, magnesium oxide), conventional shale or clay stabilizers (asphaltenes, lignins, lignosulfonates) corrosion inhibitors, hydrogen sulfide scavengers, oxygen scavengers, and hydrate inhibitors, and the like. In another non-limiting embodiment, the aqueous-based drilling fluid may include an additive, such as but not necessarily limited to structural stabilizers, surfactants, viscosifiers, chelating agents, filtration control additives, suspending agents, dispersants, wetting agents, solvents, co-solvents, co-surfactants, acids, and mixtures thereof.

Such aqueous-based drilling fluids may have surfactants, such as surfactants and/or polymers present and interacting with the non-aqueous, non-oleaginous component to help the drilling fluids achieve the desired goals. It may be helpful in designing the aqueous-based drilling fluids containing the non-aqueous non-oleaginous component to match the amount of the component with the proper surfactant/drilling fluid ratio to achieve the desired dispersion for the particular drilling fluid. Surfactants are generally considered optional, but may be used to improve the quality of the dispersion of the component.

In an alternative embodiment, the aqueous-based drilling fluid may also include but is not necessarily limited to a surfactant in an amount effective to suspend the non-aqueous, non-oleaginous component in the aqueous-based drilling fluid. Such surfactants may be present in the aqueous-based drilling fluid in amounts from about 0.1 wt % independently to about 8.0 wt %, alternatively from about 0.5 wt % independently to about 5.0 wt %, where “independently” as used herein means that any lower threshold may be combined with any upper threshold to define an acceptable alternative range. The surfactant may be or include, but is not limited to non-ionic surfactants, anionic surfactants, cationic surfactants, amphoteric surfactants, dimeric or gemini surfactants, cleavable surfactants, and combinations thereof.

Suitable nonionic surfactants may include, but are not necessarily limited to, alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated or both. Suitable anionic surfactants may include alkali metal alkyl sulfates, alkyl ether sulfonates, alkyl sulfonates, alkyl aryl sulfonates, linear and branched alkyl ether sulfates and sulfonates, alcohol polypropoxylated sulfates, alcohol polyethoxylated sulfates, alcohol polypropoxylated polyethoxylated sulfates, alkyl disulfonates, alkylaryl disulfonates, alkyl disulfates, alkyl sulfosuccinates, alkyl ether sulfates, linear and branched ether sulfates, alkali metal carboxylates, fatty acid carboxylates, and phosphate esters. Suitable cationic surfactants may include, but are not necessarily limited to, arginine methyl esters, alkanolamines and alkylenediamides. Suitable surfactants may also include surfactants containing a non-ionic spacer-arm central extension and an ionic or nonionic polar group. Other suitable surfactants may be dimeric or gemini surfactants, and cleavable surfactants.

The aqueous-based drilling fluid may be used for drilling a wellbore into a subterranean reservoir containing salt. In one non-limiting example, the subterranean formation may be offshore and drilling the wellbore may be performed in the absence of a riser. A riser connects a subsea blowout preventer stack to a floating surface rig. This pipe typically takes mud returns to the surface so that the mud does not spill out of the top of the blowout preventer stack onto the seafloor. However, a riser is not particularly necessary in the methods described herein when drilling an off-shore rig because seawater may be used as a component of the aqueous-based drilling fluid when drilling a top hole section of a subterranean reservoir containing salt. Therefore, no riser is needed to carry the aqueous-based drilling fluid back to the surface.

It will be appreciated that the methods may not completely diminish the need for a minimal amount of salt in the aqueous-based drilling fluid. The methods may be considered successful if a reduced amount of salt is needed for saturation of the aqueous-based drilling fluid to thereby reduce the amount of salt leached from the subterranean formation as compared to an otherwise identical method absent the non-aqueous, non-oleaginous component. Alternatively, the methods may be considered successful if the aqueous-based drilling fluid reaches saturation with a reduced amount of salt as compared to an otherwise identical aqueous-based drilling fluid absent the non-aqueous non-oleaginous component.

In the foregoing specification, the invention has been described with reference to specific embodiments thereof, and has been described as effective in providing methods and compositions for drilling a well using an aqueous-based drilling fluid, which comprises water and a non-aqueous, non-oleaginous component. However, it will be evident that various modifications and changes can be made thereto without departing from the broader spirit or scope of the invention as set forth in the appended claims. Accordingly, the specification is to be regarded in an illustrative rather than a restrictive sense. For example, specific types of aqueous-based drilling fluids, non-aqueous, non-oleaginous components, surfactants, salts, and/or additives, but not specifically identified or tried in a particular composition or method, are expected to be within the scope of this invention.

The present invention may suitably comprise, consist or consist essentially of the elements disclosed and may be practiced in the absence of an element not disclosed. For instance, the method may consist of or consist essentially of a method for drilling a wellbore into a salt-containing subterranean reservoir by using an aqueous-based drilling fluid that may include a non-aqueous non-oleaginous component in an amount ranging from about 5 vol % to about 95 vol % of a non-aqueous, non-oleaginous component that may be a low molecular weight polyol, such as a glycol, a glycerin, polyol, alcohol, and combinations thereof

The words “comprising” and “comprises” as used throughout the claims, are to be interpreted to mean “including but not limited to” and “includes but not limited to”, respectively.

What is claimed is:

1. A method for drilling a well, the method comprising:
drilling a wellbore into a subterranean reservoir using an aqueous-based drilling fluid, wherein the subterranean reservoir comprises salt, and wherein the aqueous-based drilling fluid comprises from about 5 vol % to about 95 vol % of a non-aqueous, non-oleaginous component selected from the group consisting of glycol, glycerin, polyol, alcohol, and combinations thereof.

2. The method of claim 1, wherein the aqueous-based drilling fluid comprises a reduced amount of salt compared to an otherwise identical aqueous-based drilling fluid absent the non-aqueous, non-oleaginous component, wherein the salt in the subterranean reservoir and the salt in the aqueous-based drilling fluid are the same or different.

3. The method of claim 2, wherein the salt in the aqueous-based drilling fluid and the salt in the subterranean reservoir are independently selected from the group consisting of sodium chloride, magnesium chloride, calcium chloride, potassium chloride, sodium formate, potassium formate, cesium formate, ammonium formate, sodium bromide, potassium bromide, calcium bromide, zinc bromide, ammonium chloride, zinc chloride, calcium nitrate, potassium acetate, magnesium acetate, calcium sulfate dihydrate, and combinations thereof.

4. The method of claim 1, wherein the aqueous-based drilling fluid further comprises an additive selected from the group consisting of structural stabilizers, surfactants, viscosifiers, chelating agents, filtration control additives, suspending agents, dispersants, wetting agents, solvents, co-solvents, co-surfactants, acids, weighting agents, and mixtures thereof.

5. The method of claim 1, wherein the aqueous-based drilling fluid is selected from the group consisting of an oil-in-water fluid, an oil-in-brine fluid, and mixtures thereof.

6. The method of claim 1, wherein the aqueous-based drilling fluid further comprises a surfactant in an amount effective to suspend the non-aqueous, non-oleaginous component in the aqueous-based drilling fluid.

7. The method of claim 6, wherein the surfactant is selected from the group consisting of non-ionic surfactants, anionic surfactants, cationic surfactants, amphoteric surfactants, dimeric or gemini surfactants, cleavable surfactants, and combinations thereof.

8. The method of claim 1, wherein the subterranean formation is offshore and drilling the wellbore is performed in the absence of a riser.

9. The method of claim 1, wherein the water activity of the aqueous-based drilling fluid is reduced compared to an otherwise identical aqueous-based drilling fluid absent the non-aqueous, non-oleaginous component.

10. The method of claim 1, further comprising reducing the amount of salt leached from the subterranean formation as compared to an otherwise identical method absent the non-aqueous, non-oleaginous component.

11. The method of claim 1, wherein the non-aqueous, non-oleaginous component comprises a hydroxyl group.

12. A method for drilling a well, the method comprising:
drilling a wellbore into a subterranean reservoir using an aqueous-based drilling fluid, wherein the subterranean reservoir comprises salt, and wherein the aqueous-based drilling fluid comprises:
from about 12 vol % to about 60 vol % of a non-aqueous, non-oleaginous component selected from the group consisting of glycol, glycerin, polyol, alcohol, and combinations thereof; and
wherein the water activity of the aqueous-based drilling fluid is reduced compared to an otherwise identical aqueous-based drilling fluid absent the non-aqueous non-oleaginous component.

13. The method of claim 12, wherein the subterranean formation is offshore and drilling the wellbore is performed in the absence of a riser.

14. The method of claim 12, wherein the aqueous-based drilling fluid comprises a reduced amount of salt as compared to an aqueous-based drilling fluid absent the non-aqueous non-oleaginous component.

15. The method of claim 14, wherein the amount of salt leached from the subterranean formation is reduced as compared to an otherwise identical method absent the non-aqueous, non-oleaginous component.

16. The method of claim 14, wherein the salt in the aqueous-based drilling fluid and the salt in the subterranean reservoir are independently selected from the group consisting of sodium chloride, magnesium chloride, calcium chloride, potassium chloride, sodium formate, potassium formate, cesium formate, ammonium formate, sodium bromide, potassium bromide, calcium bromide, zinc bromide, ammonium chloride, zinc chloride, calcium nitrate, potassium acetate, magnesium acetate, calcium sulfate dihydrate and combinations thereof.

17. A method for drilling a well, the method comprising:
drilling a wellbore into a subterranean reservoir using an aqueous-based drilling fluid, wherein the subterranean reservoir comprises salt, and wherein the aqueous-based drilling fluid comprises:
from about 12 vol % to about 60 vol % of a non-aqueous, non-oleaginous component selected from the group consisting of glycol, glycerin, polyol, alcohol, and combinations thereof; and
wherein the aqueous-based drilling fluid comprises a reduced amount of salt as compared to an otherwise identical aqueous-based drilling fluid absent the non-aqueous non-oleaginous component, wherein the salt in the subterranean reservoir and the salt in the aqueous-based drilling fluid are the same or different; and
reducing the amount of salt leached from the subterranean formation compared to an otherwise identical method absent the non-aqueous, non-oleaginous component.

18. The method of claim 17, wherein the salt in the aqueous-based drilling fluid and the salt in the subterranean reservoir are independently selected from the group consisting of sodium chloride, magnesium chloride, calcium chloride, potassium chloride, sodium formate, potassium formate, cesium formate, ammonium formate, sodium bromide, potassium bromide, calcium bromide, zinc bromide, ammonium chloride, zinc chloride, calcium nitrate, potassium acetate, magnesium acetate, calcium sulfate dihydrate and combinations thereof.

19. The method of claim 17, wherein the water activity of the aqueous-based drilling fluid is reduced compared to an otherwise identical aqueous-based drilling fluid absent the non-aqueous, non-oleaginous component.

20. The method of claim 17, wherein the subterranean formation is offshore and drilling the wellbore is performed in the absence of a riser.
